(19) United States
(12) Patent Application Publication
(10) Pub. No.: US 2006/0283665 A1
(43) Pub. Date: Dec. 21, 2006

(54) Extension ladder with improved structure

(76) Inventor: Kuo-Ching Yao, Lu-chou City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/154,600

(22) Filed: Jun. 17, 2005

(51) Int. Cl. E06C 1/00

(52) U.S. Cl. 182/195

(57) ABSTRACT

An extension ladder with improved structure includes a plurality of ladder sections, connection kits, locking mechanism, and transverse step portions; wherein each ladder section is a hollow rung, and the caliber of the rung becomes smaller when it is in a higher location. The upper ladder section and lower ladder section can be interconnected and fit each other; said connection kits are horizontally provided in the upper end of said ladder section. The internal part of said connection kit is provided with a locking mechanism to snap-fit into the through hole of said ladder section to secure the extension between each ladder section. The outside of said locking mechanism is covered by the transverse step portion, by which the ladder can be assembled conveniently and securely, appliance safety can be improved, and ladder life can be prolonged.

### BACKGROUND OF THE INVENTION

2. Field of the Invention

The present invention relates to an extension ladder, and more particularly to an extension ladder apparatus, which is assembled easily and securely, providing superior safety.

2. Description of the Prior Art

Accordingly, stepladders have become a requisite tool for casual use. For example, climbing tools such as a ladder or scaffolding enable people to readily process construction or obtain the objects at a high place.

A conventional stepladder 800, as shown in FIG. 1, is assembled by two ladder sections having a footpad respectively to prevent slippage, and is provided with parallel spaced step portions therein. The stepladder appears as an A-frame ladder during usage.

Stepladders are typically large and bulky; therefore, it is uneasy and inconvenient to carry them. Moreover, the storage of a folded stepladder may occupy large space, which makes the use of a stepladder inflexible.

Accordingly, the present invention has been invented to solve the above-mentioned problems occurred in the prior art.

### SUMMARY OF THE INVENTION

Accordingly, an object of the present invention is to provide an extension ladder with improved structure, which is composed of multi-segment ladder sections, connection kits, locking mechanism, and transverse step portions, providing ease and convenience to fold and take along, store, or unfold and use.

In the extension ladder apparatus according to the present invention, the connection kits and hollow rungs are locked in place, and then stuck and fastened. This prevents these components from loose and disattachment, which serves as another object of the present invention.

The extension ladder apparatus according to the present invention, in which the locking mechanism provided inside the connection kits are wrapped by transverse step portions, and can avoid the damage of rust, which serves as further object of the present invention.

The detailed structure, application principle, function, and effects of the present invention will be more apparent from the following descriptions taken in conjunction with the accompanying drawings.

### BRIEF DESCRIPTION OF THE DRAWINGS

FIG. 1 is a three-dimensional view of the conventional extension ladder;

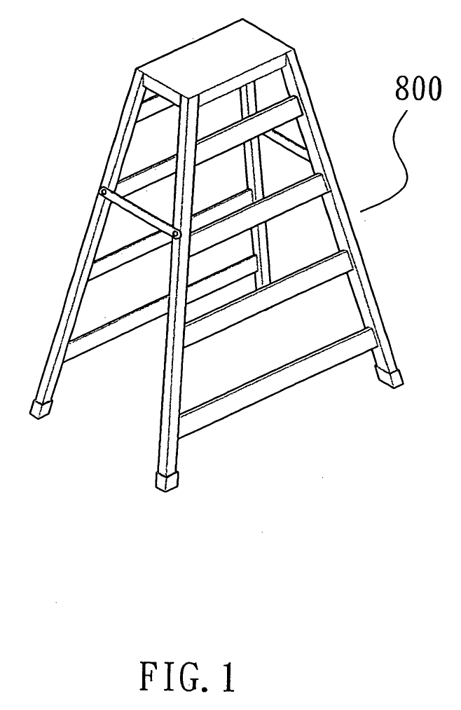

FIG. 2 is a three-dimensional view of the present invention;

FIG. 3 is a three-dimensional view showing the folding and unfolding of the push rod in the present invention;

FIG. 4A is a three-dimensional exploded view showing the ladder section and transverse step portion in the present invention;

FIG. 4B is a three-dimensional exploded view showing the partial construction of the present invention;

FIG. 5 is a three-dimensional assembly view showing the ladder section and transverse step portion in the present invention;

FIG. 6 is a sectional view showing the assembly of the ladder section and transverse step portion in the present invention; and

FIG. 7 is a sectional view of the embodiment in the present invention.

### DETAILED DESCRIPTION OF THE EMBODIMENTS

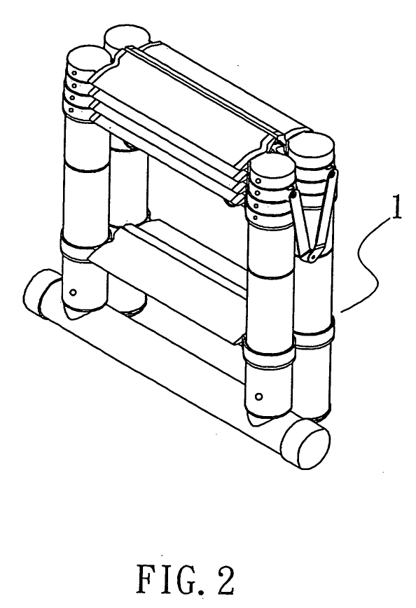

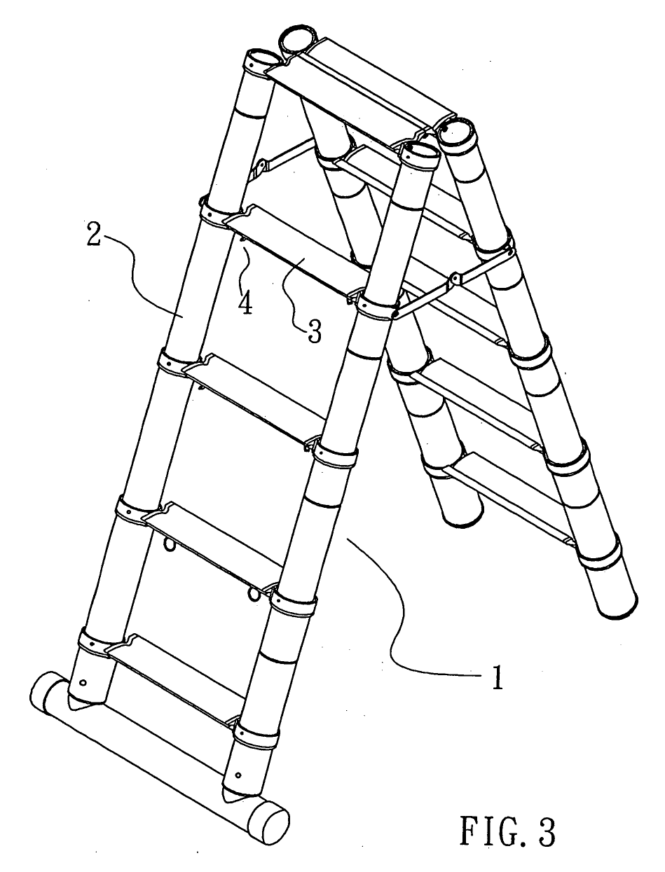

The extension ladder with improved structure in the present invention, as shown in FIG. 2, wherein the extension ladder 1 is foldable, or unfoldable as shown in FIG. 3, includes a plurality of ladder sections 2, connection kits 3, and transverse step portions 5. The stepladder appears as a rising ladder when it is unfolded and used, and can be folded by fitting the ladder sections with different calibers one another.

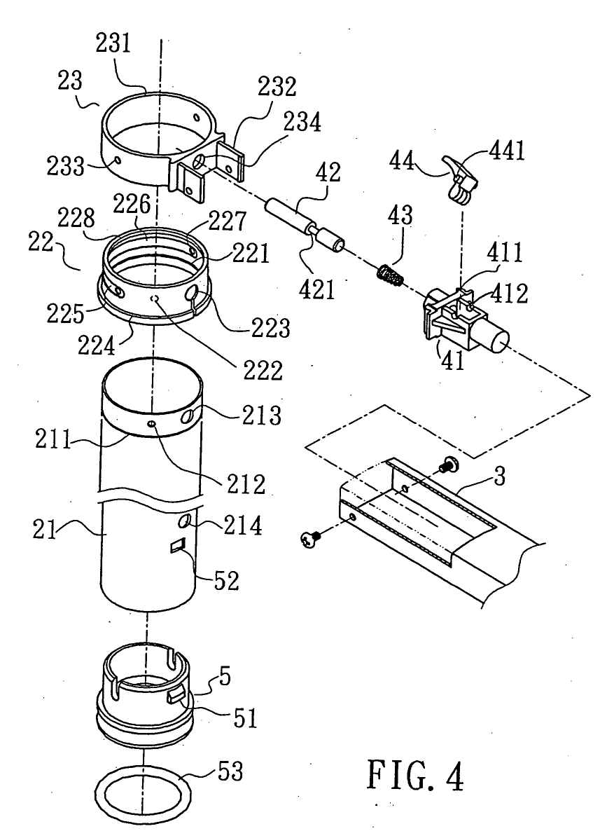

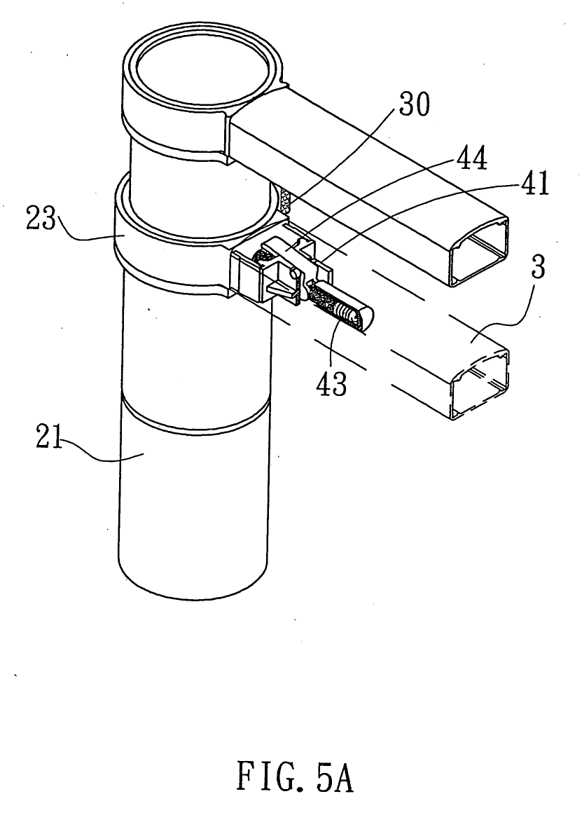

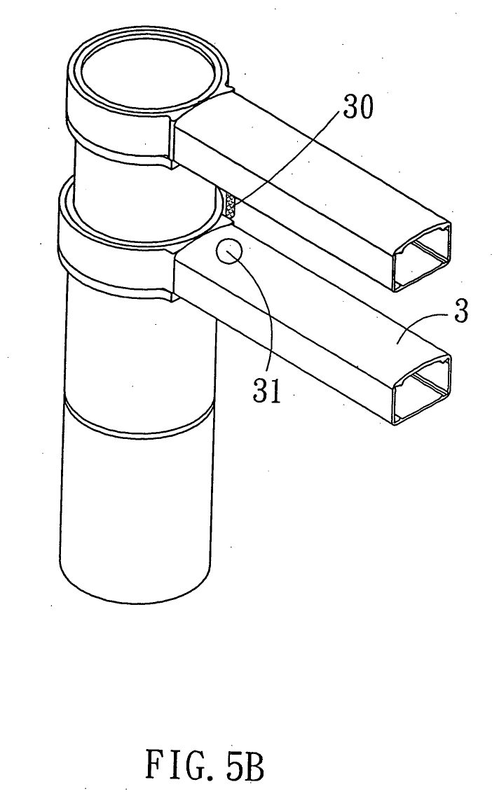

Referring to FIGS. 4 and 5, each ladder section 2 fits each other by providing similar-shaped but smaller internal ladder sections 2a. Said cannular-shaped ladder section 2 is provided with a snap-fit hole 21 and a orientation hole 22 on its upper end, and provided with a through hole 23 and opening 24 on its lower end. Also, a blocking ring 25 is provided on the upper end of said through hole 23 at proper height.

The connection kit 3 has a ringlike covering part 31 and a pivotal joint 32. Said ringlike covering part 31 is horizontally provided on the upper end of the ladder section, and affixed to the ladder section by fastening a screw therein. A plurality of orientation tenons 34 are provided on the inside of said connection kit for engaging with the snap-fit hole 21 of said ladder section, so that the connection kit can be assembled with the ladder section quickly. Also, the inside wall of said connection kit is provided with an adhesive channel 35, wherein the adhesive are infused into the adhesive-infusing hole 36 on its one end so that the connection kit can be firmly adhered to the ladder section 2. Moreover, a via hole 30 is provided on the connection kit for interconnecting with the internal channel 37 of said pivotal joint 32.

Said pivotal joint 32 is integrally molded with the ringlike covering part 31, and its internal channel 37 can be passed through. A groove 38 is provided in the end of said channel 37 for loading the locking mechanism 4.

Said locking mechanism 4, as shown in the figure, includes a locking gate 41, a locking bar 42, a spring 43, and a turning rod 44; two wings of said locking gate 41 is provided with a plug plate 411 and 412 respectively, and its center is provided with a sleeve 413. When the plug plate 411 and 412 on said locking gate are inserted into the groove 38 of the pivotal joint, the sleeve 413 is directly in the channel 37 of said pivotal joint. The inside of said sleeve 413 is provided with a spring 43 and a locking bar 42, while one end of said locking bar is firmly against the spring 43 and the other end directly faces the via hole 30 of ringlike covering part and the orientation hole 22 of said ladder section. An axle center 421 with a smaller caliber is provided in the middle of said locking bar, so that the turning rod 44 can be inserted therein and twisted. The tenons 441 on two bottom sides of said turning rod 44 are provided into the predetermined groove of said pivotal joint for orientation. Also, a fork-shaped wiper blade 442 on one end of said turning rod is inserted into said axle center 421 to control the onward and backward movement of said locking bar 42.

When the locking mechanism 4 is installed in the pivotal joint 32, the transverse step portion 5 is then provided onto the outside of said pivotal joint 32. The side wall end of said transverse step portion 5 is provided with a cross hole 51 for the turning rod 44 to extend out forwardly for the twist and control.

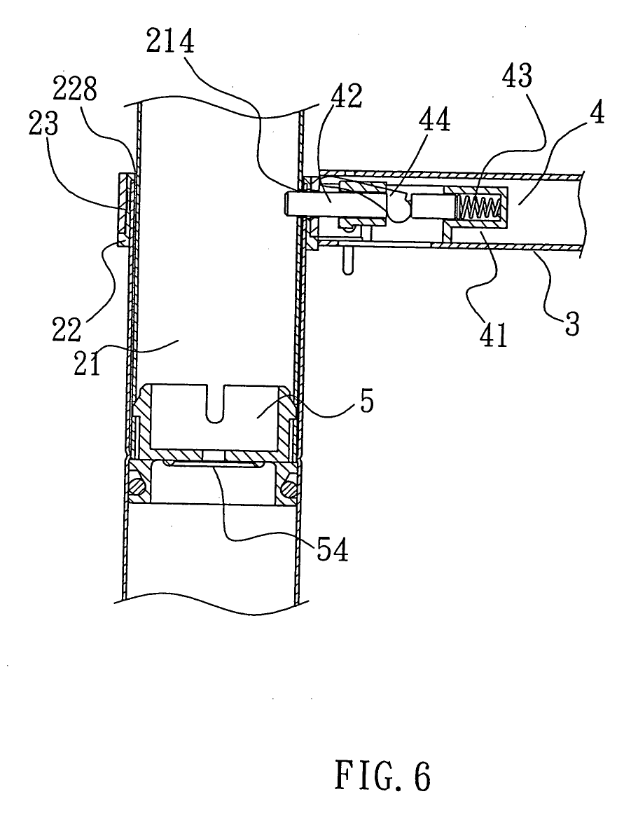

In addition, the lower end of the hollow rung 21 is provided with a sleeve-shaped buffering device 6. The upper end of said buffering device, by means of a hooked tip 61 provided thereon, is affixed to the opening 24 of said ladder section 2. The lower-end outside of said buffering device is provided with an elastic seal ring 62 to increase friction when it contacts with the inside of said rung and reduce noise. Also, as shown in FIG. 6, the internal part of said buffering device is provided with a mylar 63 with its surface having a hole, which allows airs to enter the cavity of said mylar 63 when the buffering device 6 moves upward and downward, and thus enhances the cushion effect.

When the assembling has been completed, as shown in the figure, the bottom of the ladder section 2 is provided with a buffering device 6 and an elastic seal ring 62 to increase the friction between the ladder section and the inside wall of internal ladder section, so that the purpose of slowing down the descending can be achieved. Also, the connection kit and the upper end of said ladder section are provided with adhesive channel 35 to infuse the adhesive therein, so that the connection kit and the ladder section can be adhered to each other. Accordingly, the present extension ladder is assembled integrally and securely. Moreover, the provided locking mechanism 4 is fully covered by the connection kit 3 and the transverse step portion 5, which not only makes it easy and convenient to control the locking mechanism, but also prevents the damage caused by any foreign object.

As shown in FIG. 6, when the internal ladder section 2a and ladder section 2 are extended to use relatively, the blocking ring 2a1 having a larger caliber on the outside of said internal ladder section 2a is firmly against the inwardly protruding ring 311 of said connection kit in the external ladder section. Meanwhile, the through hole 2a2 on the lower end of said internal ladder section 2a is directly located in a route having the orientation hole 22 of said external ladder section, via hole 30 of said connection kit, and locking bar 42a, which enables the locking bar 42 to be inserted in the fixed position smoothly when it is moved forward.

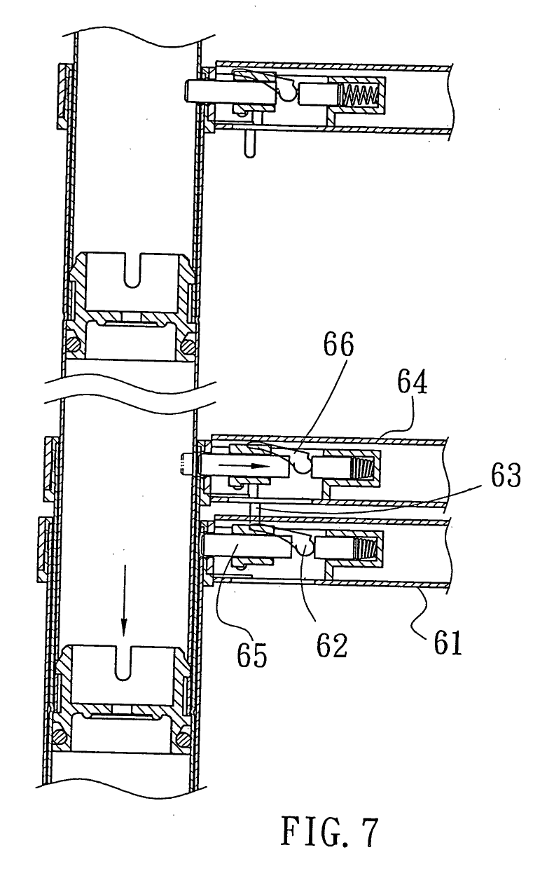

In the following description and drawings, different reference numerals are used to designate different components. When a stepladder is folded, as shown in FIG. 7, the first-level turning rod 71 is twisted backward to force the locking bar 72 to withdraw from the through hole of second ladder section 73. Then, the second ladder section 73 falls downward along with the second transverse step portion 74 owing to a lack of any obstruction. Similarly, if the turning rod 75 is twisted backward, the locking rod 77 shall be forced to withdraw from the through hole. Then, the third ladder section 78 together with the third transverse step portion 79 falls down consequently. On the analogy of this, all rung sections and step portions can be folded quickly.

Accordingly, the extension ladder with improved structure in the present invention are integrally assembled securely by providing a snap-fit hole 21, orientation tenon 34, and blocking ring 25 between the connection kit 3 and ladder section 2 for quick and correct orientation. Also, the ladder assembly can be securely by providing with the adhesive channel 35. Furthermore, the locking mechanism 4 is provided on the connection kit 3 for making the assembling more convenient, the control of the ladder easier, and prolonging ladder life.

As described above, the extension ladder apparatus in the present invention certainly enhances appliance safety, and makes folding and using quick and convenient, which can improve the deficiencies of conventional ladders. Also, the present invention has not yet opened to public, it is then complied with the conditions of allowable patents.

Although the above-mentioned embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An extension ladder with improved structure, comprising: A plurality of ladder sections, connection kits, locking mechanism, and transverse step portions, wherein each ladder section is a hollow rung having different caliber, which can be interconnected by fitting each other and pulled and extended; its upper end is horizontally provided with a connection kit, while the inside of said connection kit is provided with a locking mechanism covered by said transverse step portion.

2. The extension ladder with improved structure as claimed in claim 1, wherein said ladder section and connection kit are adhered to each other by engaging the orientation hole on the ladder section with the orientation tenon of said connection kit, and then infusing the adhesive into the adhesive channel on the inside of said connection kit.

3. The extension ladder with improved structure as claimed in claim 1, wherein the joint part of said ladder section and connection kit is provided with a orientation hole to interconnect with the through hole of said connection kit, so that the locking bar of the locking mechanism in the internal part of said connection kit can be moved forward and backward to the predetermined position through the joint part.

4. The extension ladder with improved structure as claimed in claim 3, wherein said connection kit is connected with the ladder section by means of the ringlike covering part, and the pivotal joint on the connection kit is provided with a locking mechanism.

5. The improved extension ladder apparatus as claimed in claim 4, wherein said locking mechanism is inserted into the pivotal joint by means of the locking gate, so that the sleeve in the middle of said locking gate is placed in the channel of said pivotal joint; said sleeve is provided with a spring and a locking bar, and the locking bar should pass through the through hole of said pivotal joint to the orientation hole of said ladder section.

6. The extension ladder with improved structure as claimed in claim 5, wherein said locking mechanism can control the onward and backward movement of the locking bar by means of a fork-shaped turning rod.

7. The extension ladder with improved structure as claimed in claim 1, wherein the bottom segment of said ladder section is provided with a through hole for the locking mechanism of said external ladder section to insert therein when the external ladder section and said ladder section are extended to use relatively.

8. The extension ladder with improved structure as claimed in claim 7, wherein said ladder section is provided with a blocking ring having a relatively large caliber in the position above the through hole; when the external ladder section is extended and used, the blocking ring is firmly against the inwardly protruding ring of the connection kit in the external ladder section, which ensures that the through hole is located in the position relative to the orientation hole, via hole, and locking bar.

9. The extension ladder with improved structure as claimed in claim 1, wherein the lower end of said ladder section is provided with a sleeve-shaped buffering device, and an elastic seal ring is provided on the bottom outer rim of said buffering device to maintain friction when it contacts with the inside of said rung, and to reduce noise and slow down the folding.

10. The extension ladder with improved structure as claimed in claim 9, wherein the inside of said buffering device is provided with a mylar, on which a hole is formed to enhance the cushion effect by allowing airs to enter into the cavity of said mylar via the holes when the buffering device moves upward and downward.
